(19) United States
(12) Patent Application Publication
(10) Pub. No.: US 2026/0131222 A1
(43) Pub. Date: May 14, 2026

(54) AUGMENTED REALITY VOCABULARY CARD GAME

(71) Applicant: DATA MEA LLC, San Juan, PR (US)

(72) Inventor: Mayra Rios Collazo, San Juan, PR (US)

(73) Assignee: DATA MEA LLC, San Juan, PR (US)

(21) Appl. No.: 19/121,066

(22) PCT Filed: Oct. 13, 2023
(86) PCT No.: PCT/US23/35136

§ 371 Date: Apr. 14, 2025

Related U.S. Application Data
(60) Provisional application No. 63/416,433, filed on Oct. 14, 2022.

(51) Int. Cl. A63F 1/04; A63F 13/213; A63F 13/35; A63F 13/69

(52) U.S. Cl. CPC A63F 1/04; A63F 13/213; A63F 13/35; A63F 13/69

(57) ABSTRACT

An augmented reality vocabulary card game, wherein the player uses a camera from a device to search for a card comprising augmented reality technology to show an image that matches a given word. The player can access the game using an electronic device and the game will provide a word. Upon receiving the word, the player scans the playing cards that are distributed in a playing area using the camera on the device, until the correct image is displayed on the device screen. If the correct image is found on time, the counter will stop and the game will provide a score. If the image is not found on time, the game is over.

### STATEMENT REGARDING FEDERALLY SPONSORED RESEARCH OR DEVELOPMENT

N/A

### BACKGROUND OF THE DISCLOSURE

### 1. Field of Invention

The present disclosure relates to a system and method for a card game accompanied with computer implemented augmented reality. The game uses the interactions between a player, a set of cards, a smart device or computer, and a computer server, to implement computer instructions wherein the player is prompted to find a virtual image associated with a word, randomly selected by an algorithm.

### 2. Descriptions and Shortcomings of the Related Art

Children's lifestyles and daily routines have been severely impacted by the constant use of electronics as a source of entertainment. Moreover, as a result of the COVID-19 pandemic, children's education has transformed towards homeschooling and distanced learning, which has resulted in more sedentary behavior in children. The confinement restrictions implemented during the COVID-19 pandemic have reduced children's physical activity and increased the use of electronics, which can have potentially adverse effects on their health.

The present disclosure reduces children's sedentary behavior and fosters cognitive, motor, linguistic and social skills by providing an interactive vocabulary card game, which is useful for teachers, therapists, editors and the general public. Said vocabulary card game uses augmented reality (“AR”) to match a given word with an image functionally associated to a card. The user must match the image to the word by walking around a playing area or game zone, holding an electronic device that shows the image on the device when the device camera points towards a specific card.

The present disclosure improves linguistic and cognitive skill development through the progressive building of learning skills, such as vocabulary development, sustaining attention, improving memory, and thinking process. For example, the game associates words with themes and images, and repeats the process as the user replays the game. Linguistic skills allow an individual to understand, think, and express themselves. Through the present disclosure, linguistic skills can be developed by learning basic vocabulary words and associating those words in accordance with a particular context. By requiring the user to walk around a playing area, the game allows for the development of fine motor skills, such as hand and wrist movement, and gross motor skills, such as arm and leg movement. Moreover, users can develop social skills by learning about real-life situations and social topics presented within the themes of the game.

Currently there are many vocabulary games involving cards. However, existing games lack the advantages and functionalities of the present disclosure. For example, US 20130078599A1 discloses a card game for learning the Greek alphabet. However, the foregoing disclosure does not provide for the development of motor skills by incorporating movement into the method of the game. It also lacks the augmented reality technology that allows the player to scan the cards by moving around a playing area and displays an image on a device screen. Moreover, US 202000941134A1 discloses an image capturing device that captures an image on a game token to execute and implement a virtual card game, wherein said game creates virtual playing cards based on the recognized game tokens. In contrast, the present disclosure integrates the use of physical playing cards with vocabulary related to a theme, and a virtual image of the vocabulary functionally related to a playing card. In CN 105749552A, a fixed image on a card is associated with a unique code on a remote server, wherein the remote server returns the “state” of the image, and the state is updated in order for the user to obtain different real-time states or statuses of a specific card corresponding to the unique code, based on the progress of the game. Contrary to the foregoing, the present disclosure uses augmented reality to display images related to different cards in order for the user to select a particular image to develop cognitive, language and motor skills. Specifically, in the game of the present disclosure, the player uses a device to scan a physical card which contains a marker that gives access to the game server, where the user or player can choose a theme to play a vocabulary game. Said vocabulary game uses Augmented Reality technology, by scanning a physical playing card, to show in the device a virtual image that is randomly chosen by the algorithm of the vocabulary game. Moreover, the virtual images are shuffled by an algorithm so that a card marker is assigned a different virtual image every time a new game is played.

### BRIEF DESCRIPTION OF THE DRAWINGS

FIG. 1 shows a typical embodiment of the system that performs the functions of the present invention.

FIG. 2 shows a flowchart of the process by which the game is set up.

FIG. 3 shows a flowchart of the process for conducting the game.

### DETAILED DESCRIPTION OF THE PREFERRED EMBODIMENT

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning-i.e. that it will be taken to mean an inclusion of not only the listed components it directly references, but also other non-specified components or elements. This rationale will also be used when the term ‘comprised’ or ‘comprising’ is used in relation to one or more steps in a method or process.

When the word “invention” may be used in this specification, the word “invention” includes “inventions”, that is, the plural of “invention”. By stating “invention”, the Applicant does not in any way admit that the present application does not include more than one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

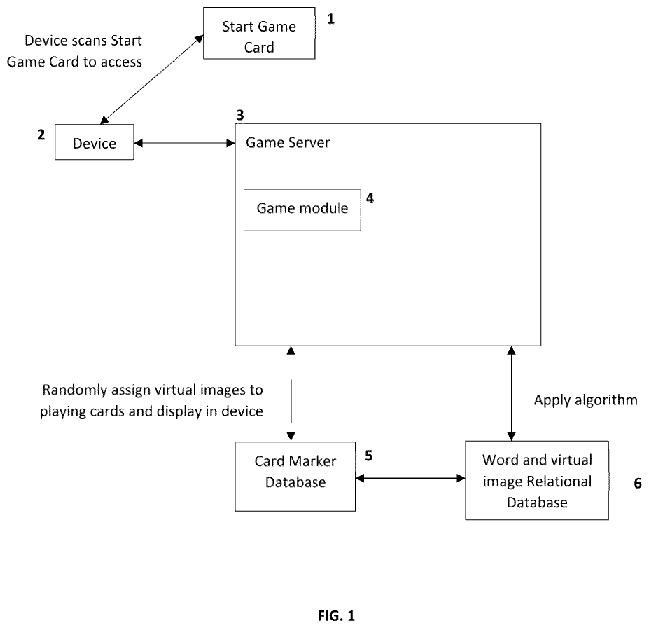

The present disclosure is a vocabulary card game that uses augmented reality (“AR”) technology. FIG. 1 shows a typical embodiment of the system that performs the functions of the game of the present disclosure, which includes physical game cards (including a start game card 1 and playing cards) that contain a marker or a pattern associated to a “.patt” file stored in a game server 3 and are readable by a device 2 camera. In one embodiment, before starting the game, the player spreads the playing cards around a room or space.

In one embodiment, the game requires using a device 2 camera to scan the start game card 1 which contains a marker that links to the game server 3. The game server 3 contains a gaming module 4 that shows a game gallery on the device 2, which includes different games for the player to choose from. Each game has a different theme and sets of words associated with each theme. For example, the theme “transportation” can be associated with words like “train”, “car”, “plane”, etc. Each word is associated to a virtual image of the object or concept the word denotes. Each virtual image is a “.patt” file stored in the game server 3. In an embodiment, the words and virtual images are stored in a database 6 that assigns a specific virtual image to each word. A card marker database 5 stores the marker contained in each playing card and the algorithm randomly assigns a virtual image to each marker.

In one embodiment, the game uses “A-Frame” and “Three.js” frameworks. A-Frame is an entity component system framework for Three.js, where developers can create three dimensional (“3D”) and virtual reality scenes using hypertext markup language (“HTML”). Three.js is a 3D library that is used to create and display 3D content on a webpage. Different known Augmented Reality frameworks may be used to obtain the functionalities disclosed in this disclosure.

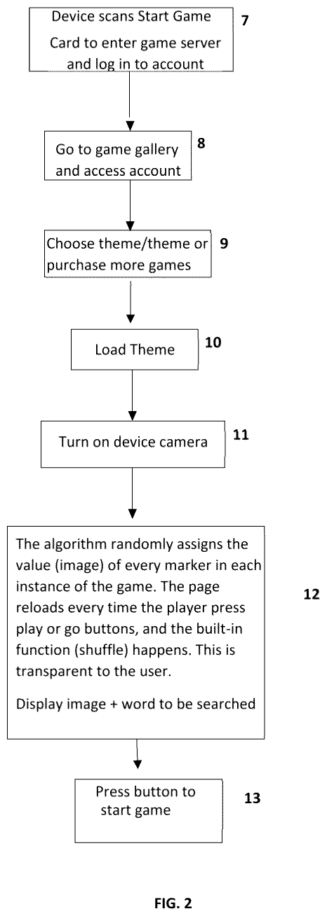

The present game operates in a remote game server 3. FIG. 2 shows that the game can be accessed by using the device camera to scan the start game card 7 to log into the player's account and access the game server 3 that displays the game gallery on the screen of the device. Once the player enters the game server, the player can access the gaming module 4, which allows the player to choose the game from the game gallery once the player's account is accessed 8 and select a theme or buy more games 9. Once the player selects the game 8 and a theme 9, a “scene” is displayed on the device screen 10. The scene shows features of the game, such as score, time counter, logo, given word, decorations and a theme. When the game is played, after the theme is selected 9, the scene is uploaded, the device camera is activated 11 and a word selected from the set of words related to the theme is shown on the device screen 12. The game includes a gamification feature that allows the device camera to rotate the scene in panorama mode. The word is randomly chosen by the gaming module 4 using an algorithm. The algorithm also randomly selects the virtual images that will be used for the game. The player must scan the start game card to start the time counter and begin playing the game 13. When the counter is started, a virtual image is randomly assigned through an algorithm to the markers in each playing card, so that, when the device camera scans the playing cards, a virtual image can be seen “floating” above each playing card. One of the virtual images assigned to the playing cards will be the virtual image associated to the randomly chosen word, and the remaining images will not. The algorithm uses a shuffle function to change in each play the marker to which an image is assigned to increase the difficulty of the game and avoid winning by memorization of the card with the word instead of association of the word and the virtual image.

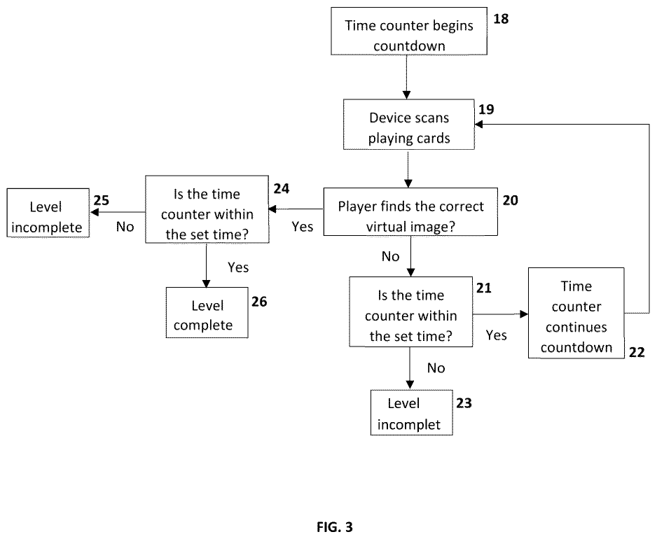

Once the game is selected, the time counter starts, as FIG. 3 shows. For example, in an embodiment the time counter can be set for thirty (30) seconds. When the time counter begins, the player must move the device camera scanning the playing cards spread throughout the room or space in order to search for a virtual image that matches with the randomly selected word 18. Said virtual image will appear in one of the different playing cards that are scattered or distributed across a play area near the player. The player must find the card with the correct image, using the device to scan the different playing cards, within the time set in the time counter 19. Once the player finds and selects a virtual images, the algorithm will check if the selected image is the correct image associated to the selected word 20. After the image is selected, the algorithm will check the time counter 24, and if the time counter has not reached zero (“0”), the device will show a message notifying that the player has completed a level in the game and showing the results of the game 26. The player wins the game when a specific number of levels have been completed. For example, the player can win the game if three levels are completed. In an embodiment, the player must select the correct image five times within thirty (30) seconds. The player must achieve this twice in order to complete one level. The player cannot continue to the next level until the previous level is completed. The player must complete the last level in order to accumulate a record, which includes statistics of the player's execution in the game, such as, for example, total steps taken by the player during the game. The record can be shared with the player. For example, the record can be shared via email with the player.

If the counter reaches zero (“0”) seconds before the player finds the correct image, the device will show a message notifying that the player has done a good effort, but has not completed the level, and showing the results of the game 27. If the player does not select the correct image, the algorithm will check if there is time left in the time counter 21. If the time counter has reached zero (“0”), the game is over 23. If there is time left in the time counter, the time counter will continue the countdown 22 and the player may continue scanning the playing cards in order to find the correct virtual image. In some embodiments, the algorithm does not verify whether the player selected the correct image, and it is up to the player or a supervisor to confirm the correct image is selected. If the player finds the image within said time, the time counter will stop. When the time counter stops, or when the time counter reaches zero (“0”), the game will show a score, which will depend on the time consumed by the player in order to finish the game. The player can press on a virtual image on the device screen to make the selection and the counter will stop, and the game module 4 will determine if the image selected matches the displayed word and grant the appropriate score.

Physical playing cards are needed in order to play the game. The playing cards are universal and can be used with the different games on the game gallery. In one embodiment, the cards include “.patt” files that allow the camera of the device 2 to read the physical card and show the images with augmented reality. Similar Augmented Reality files can be used instead of “.patt” files. The device 2 scans and reads the cards, which are created using a marker generator. The marker generator defines different 3D scenes or images for particular markers, so when the device 2 recognizes a marker, the application shows the 3D image on the corresponding marker. In other words, the device 2 registers an event every time a playing card is found and scanned, wherein the algorithm shows on the device the name of the image and the image rendered by the device. In some embodiments, the images are 2D images. The images related to the words given by the algorithm of the game are present in each playing card that is scattered across the playing area, but the player cannot see them until the image is rendered by the camera once it focuses on the playing cards.

The scene on the device 2 screen also comprises sounds, which are compliant with the best practices and policies for playing audio on the web. When a user or player opens a webpage or application, spontaneous noises or sounds can be an unwelcomed and inconvenient distraction. Therefore, the best practice for automatically playing audio on the web is to allow it to play automatically only under specific circumstances. For example, when a video with audio, or an audio track, automatically begins to play, said video or audio track can be configured to be muted by default.

Another embodiment of the present disclosure incorporates the use of stickers or wall decals, rather than cards. The stickers or wall decals are placed in public areas, such as, cinemas, shopping centers, care centers, schools, theaters, airports, among others. In this embodiment, the player uses the device to scan the markers that are located within the wall decal in order to start and play the game. The wall decal embodiment of the present disclosure comprises the same algorithm as the card embodiment. However, the wall decal game is also directed towards obtaining promotions, offers and/or discounts from a particular brand or merchant. Therefore, the words the player receives are related to said brand or merchant. This embodiment also serves as a “selfie spot”, wherein the player can take a picture of themselves and upload it to other applications, such as social media applications. The player must play and win the game in order to receive the promotion, offer or discount from the merchant. The specifications of the promotion, offer or discount will depend on the game and the merchant.

Another embodiment of this invention positions the markers across a particular location as a marketing tool, wherein the invention can be used for a merchant's advertising campaign. The device 2 scans the markers that are positioned across the location in order to start and play the game. This embodiment is directed towards obtaining promotions, offers and/or discounts from a particular brand, merchant or product. Therefore, the game will show vocabulary words related to a merchant's brand or product.

While the disclosure includes reference to specific embodiments, it will be understood by those skilled in the art that various changes may be made and equivalents may be substituted for elements thereof without departing from the true spirit and scope of the disclosure. In addition, many modifications may be made without departing from the essential teachings of the disclosure. When reference is made to specific known applications or systems, it will be understood by those skilled in the art that various substitutes and alternatives may be available.

1. A method for a vocabulary card game with computer implemented augmented reality comprising the steps of:
providing a set of physical game cards wherein said set of physical game cards comprises a start game card, a first playing card and a set of remaining playing cards;
wherein the start game card, the first playing card and the set of remaining playing cards comprise a marker that is stored in a card marker database and is associated to a virtual image in a word and virtual image relational database;
wherein the marker in the start game card, the first playing card and the set of remaining playing cards is associated to a file stored in a game server;
wherein the start game card, the first playing card and the set of remaining playing cards are readable by a device;
providing a link to the game server through a URL that is functionally attached to the marker in the start game card;
providing access to the game server through the URL wherein said game server comprises a gaming module that includes a set of multiple games and a set of multiple themes, wherein each theme in the set of multiple themes is associated to a set of words in the word and virtual image relational database and each word in the set of words is associated to a virtual image in the word and virtual image relational database;
receiving a command in the gaming module in the game server wherein said command selects a chosen game from the set of multiple games and a chosen theme from the set of multiple themes; searching a theme identification number in the word and virtual image relational database associated with the chosen theme;
randomly selecting, by the gaming module using an algorithm, a word identification number associated with a chosen word from the set of words in the word and virtual image relational database associated with the theme identification number of the chosen theme;
randomly selecting a relational identification number in the word and virtual image relational database associated with a virtual image from a first set of virtual images that is related to the word identification number;
randomly selecting a set identification number in the word and virtual image relational database associated with a second set of virtual images that is not related to the word identification number;
allowing the device to display the chosen game and chosen theme related to the theme identification number;
allowing the device to display the chosen word associated with the word identification number;
allowing the activation of a camera on the device;
receiving a command in the gaming module in the game server to start a time counter and being the game;
randomly assigning, using the algorithm in the gaming module, the relational identification number, to a marker associated with the first playing card;
randomly assigning, using the algorithm in the gaming module, a virtual image identification number, associated with each virtual image in the set of virtual images related to the set identification number, to each marker associated with the each of the set of remaining playing cards; allowing the device to display the virtual image related to the relational identification number above the first playing card and each virtual image related to each virtual image identification number in the set of virtual images above the each of the set of remaining playing cards;
receiving from the camera on the device a first marker identification number;
determining if the first marker identification number is associated with the relational identification number and if the time counter has reached zero;
receiving from the device a command in the gaming module in the game server to stop the time counter;
allowing the device to display a first message showing that a word in the vocabulary card game has been identified and results from the vocabulary card game if the time counter is stopped;
allowing the device to display a second message showing that the word in the vocabulary card game has not been identified and results from the vocabulary card game if the first marker identification number is associated with the relational identification number and if the time counter has reached zero;
allowing the device to display a third message showing that the word in the vocabulary card game has not been identified and results from the vocabulary card game if the first marker identification number is not associated with the relational identification number and if the time counter has reached zero; and
allowing the device to continue displaying virtual images related to the relational identification number above the first playing card and each virtual image related to each virtual image identification number in the set of virtual images above the each of the set of remaining playing cards if the first marker identification number is not associated with the relational identification number and if the time counter has not reached zero until the time counter reaches zero or, if the time counter has not reached zero, until a marker identification number is received from the device, wherein said maker identification number is associated with the relational identification number.

2. The method as in claim 1, wherein each virtual image from the word and virtual image relation database is a three-dimensional image.

3. The method as in claim 1, wherein each virtual image from the word and virtual image relation database is a two-dimensional image.

4. The method as in claim 1, wherein the chosen theme comprises a set of sounds from a database, wherein said set of sounds has a sound identification number that is related to the theme identification number.

5. The method as in claim 1, further comprising the steps of:
randomly reassigning, using the algorithm in the gaming module, the relational identification number, from the marker associated to the first playing card to a marker associated with a second playing card; and
randomly reassigning, using the algorithm in the gaming module, the virtual image identification number, associated with each virtual image in the set of virtual images related to the set identification number, from each marker associated with the each of the set of remaining playing cards to the marker associated with the first playing card and to each marker associated with each of the playing cards in a second set of remaining playing cards wherein said second set of remaining playing cards does not include the second playing card.
